(19) United States
(12) Patent Application Publication
(10) Pub. No.: US 2016/0160837 A1
(43) Pub. Date: Jun. 9, 2016

(54) PULTRUDED ROTOR BLADE COMPONENTS HAVING INTERLOCKING EDGES

(71) Applicant: General Electric Company, Schenectady, NY (US)

(72) Inventors: Shannon B. Geiger, Greenville, SC (US); Christopher Daniel Caruso, Greenville, SC (US); Aaron A. Yarbrough, Clemson, SC (US)

(21) Appl. No.: 14/560,266

(22) Filed: Dec. 4, 2014

(51) Int. Cl. F03D 1/06; F03D 1/00

(52) U.S. Cl. CPC F03D 1/0675; F03D 1/001

(57) ABSTRACT

Rotor blade components for wind turbines having interlocking edges and methods of manufacturing same are disclosed. In one aspect of the present disclosure, the rotor blade component includes a plurality of pultruded members arranged in one or more layers. Each of the pultruded members are constructed of a plurality of fibers joined together via a cured resin material. Further, each of the plurality of pultruded members includes one or more interlocking edges. Thus, adjacent pultruded members may be aligned via corresponding interlocking edges. The pultruded members are further secured together to create a single structural member.

### FIELD OF THE INVENTION

The present subject matter relates generally to rotor blades of a wind turbine and, more particularly, to pultruded rotor blade components having interlocking edges.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

Wind turbine rotor blades generally include a body shell formed by two shell halves of a composite laminate material. The shell halves are generally manufactured using molding processes and then coupled together along the corresponding ends of the rotor blade. In general, the body shell is relatively lightweight and has structural properties (e.g., stiffness, buckling resistance and strength) which are not configured to withstand the bending moments and other loads exerted on the rotor blade during operation. In addition, wind turbine blades are becoming increasingly longer in order to produce more power. As a result, the blades must be stiffer and thus heavier so as to mitigate loads on the rotor.

To increase the stiffness, buckling resistance and strength of the rotor blade, the body shell is typically reinforced using one or more structural components (e.g. opposing spar caps with a shear web configured therebetween) that engage the inner surfaces of the shell halves. The spar caps may be constructed of various materials, including but not limited to glass fiber laminate composites and/or carbon fiber laminate composites. Such materials, however, can be difficult to control, defect prone, and/or highly labor intensive due to handling of the dry and pre-preg fabrics and the challenges of infusing large laminated structures.

As such, modern spar caps can be constructed of pre-fabricated, pre-cured (i.e. pultruded) composites that can be produced in thicker sections, and are less susceptible to defects. Accordingly, the pultruded composites can eliminate various concerns and challenges associated with using dry fabric alone. As used herein, the terms “pultruded composites,” “pultrusions,” “pultruded members” or similar generally encompass reinforced materials (e.g. fibers or woven or braided strands) that are impregnated with a resin and pulled through a stationary die such that the resin cures or undergoes polymerization through added heat or other curing methods. As such, the process of manufacturing pultruded composites is typically characterized by a continuous process of composite materials that produces composite parts having a constant cross-section. A plurality of pultrusions can then be joined together to form the spar caps and/or various other rotor blade components.

Accordingly, the art is continuously seeking new and improved methods of manufacturing rotor blade components, such as the spar caps, using pultruded members. More specifically, methods of manufacturing rotor blade components having interlocking pultrusions would be advantageous.

### BRIEF DESCRIPTION OF THE INVENTION

Aspects and advantages of the invention will be set forth in part in the following description, or may be obvious from the description, or may be learned through practice of the invention.

In one aspect of the present disclosure, a rotor blade component for a wind turbine is disclosed. The rotor blade component includes a plurality of pultruded members arranged in one or more layers. Each of the pultruded members are constructed of a plurality of fibers joined together via a cured resin material. Further, each of the plurality of pultruded members includes one or more interlocking edges. Thus, adjacent pultruded members are aligned together via corresponding interlocking edges.

In one embodiment, the rotor blade component includes at least one of a spar cap, a shear web, a root ring, or similar. In another embodiment, the one or more interlocking edges correspond to at least one of interlocking side edges, interlocking top edges or interlocking bottom edges. As such, in certain embodiments, adjacent pultruded members of one layer may be aligned together via corresponding interlocking side edges. In further embodiments, adjacent pultruded members of different layers may be aligned together via corresponding interlocking top and bottom edges.

In additional embodiments, the interlocking edges may have any suitable configuration. For example, in particular embodiments, the interlocking edges may include any of the following cross-sectional shapes: dovetail, arcuate, rectangular, square, V-shaped, U-shaped, ball joint, or any other suitable shape.

In further embodiments, the aligned pultruded members may be further joined together via at least one of vacuum infusion, an adhesive, a pre-preg material, a semi-preg material, or any other suitable joining method. In certain embodiments, the plurality of fibers used to construct the pultruded members may be glass fibers, carbon fibers, or similar. Further, the resin material may be any suitable resin material, including but not limited to polyester, polyurethane, polybutylene terephthalate (PBT), polyethylene terephthalate (PET), vinylester, epoxy, or similar.

In another aspect, the present disclosure is directed to a rotor blade of a wind turbine. The rotor blade includes a blade root and a blade tip, leading and trailing edges, suction and pressure sides, and at least one spar cap configured on an internal surface of either or both of the pressure or suction sides. The spar cap includes a plurality of pultruded members arranged in one or more layers. Each of the pultruded members are constructed of a plurality of fibers joined together via a cured resin material. Further, each of the plurality of pultruded members includes one or more interlocking edges. Thus, adjacent pultruded members are aligned together via corresponding interlocking edges. It should be understood that the rotor blade and spar cap may be further configured with any of the additional features as described herein.

In yet another aspect, the present disclosure is directed to a method of manufacturing a rotor blade component of a wind turbine. The method includes providing one or more pultruded members, each of the pultruded members comprising one or more interlocking edges. Another step includes aligning the plurality of pultruded members together via corresponding interlocking edges. The method also includes securing the aligned pultruded members together to form the rotor blade component.

As mentioned, in various embodiments, the rotor blade component may include any suitable component, including but not limited to a spar cap, a shear web, or a root ring.

In further embodiments, the step of aligning the pultruded members together via the interlocking edges may also include aligning corresponding interlocking side edges or corresponding interlocking top or bottom edges of adjacent pultruded members. In still another embodiment, the method may also include securing the aligned pultruded members together by joining the pultruded members together via at least one of vacuum infusion, an adhesive, a pre-preg material, a semi-preg material, or any other suitable joining method.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one of the rotor blades of FIG. 1;

FIG. 3 illustrates a cross-sectional view of the rotor blade of FIG. 2 along line 3-3;

FIG. 4 illustrates a cross-sectional view of one embodiment of a pultruded spar cap according to the present disclosure;

FIG. 5 illustrates a cross-sectional view of one of the pultruded members of the spar cap of FIG. 4;

FIG. 6 illustrates a cross-sectional view of one embodiment of a pultruded spar cap according to the present disclosure;

FIG. 7 illustrates cross-sectional views of further embodiments of spar caps according to the present disclosure, particularly illustrating single, separate pultruded members that each form a layer of the spar cap;

FIG. 8 illustrates cross-sectional views of various embodiments of interlocking components configured to form one or more layers of a pultruded spar cap according to the present disclosure;

FIG. 9 illustrates cross-sectional views of various embodiments of interlocking components and layers configured to form a pultruded spar cap according to the present disclosure; and

FIG. 10 illustrates a flow diagram of a method of manufacturing rotor blade components according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to improved pultruded rotor blade components for a wind turbine and methods of manufacturing same. For example, in one embodiment, the rotor blade component includes a plurality of pultruded members arranged in one or more layers. Each of the pultruded members are constructed of a plurality of fibers cured together via a resin material. During the pultrusion process, the components are molded and cured to include one or more interlocking edges. Thus, the pultruded members can be arranged in one or more layers and connected and/or self-aligned with adjacent pultruded members via corresponding interlocking edges. More specifically, in certain embodiments, the rotor blade component may include one pultruded member per layer, multiple pultruded members per layer, and may include one or more layers.

The present disclosure provides many advantages not present in the prior art. For example, the rotor blade components of the present disclosure are less prone to defects and have known material properties. Further, since the rotor blade components are pre-cured, wrinkling and dis-bonding of the layers are reduced and/or eliminated. In addition, because the rotor blade components are designed to a known height as defined by the heated die, the pultruded member thickness tolerance and stack-up can be more tightly controlled, thereby reducing cycle time for the manufacturing process.

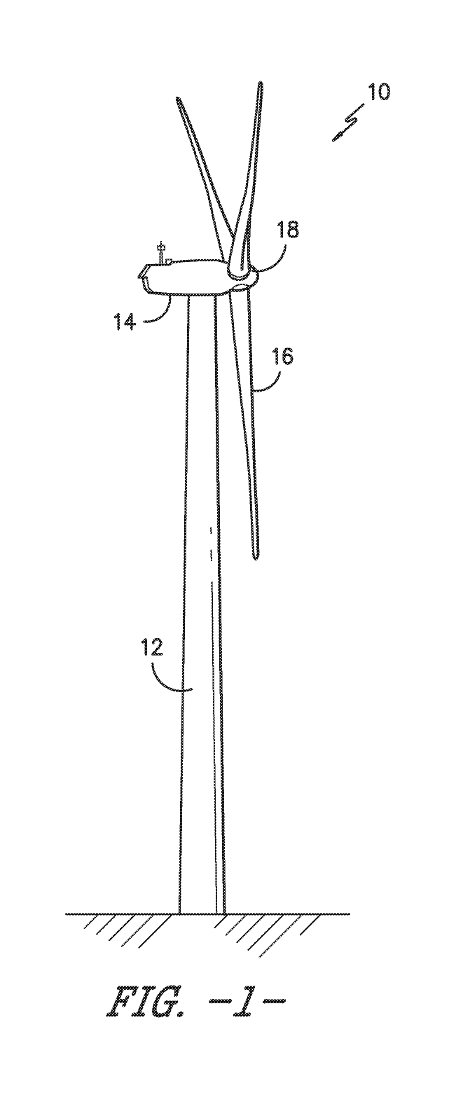

Referring now to the drawings, FIG. 1 illustrates a perspective view of a horizontal axis wind turbine 10. It should be appreciated that the wind turbine 10 may also be a vertical-axis wind turbine. As shown in the illustrated embodiment, the wind turbine 10 includes a tower 12, a nacelle 14 mounted on the tower 12, and a rotor hub 18 that is coupled to the nacelle 14. The tower 12 may be fabricated from tubular steel or other suitable material. The rotor hub 18 includes one or more rotor blades 16 coupled to and extending radially outward from the hub 18. As shown, the rotor hub 18 includes three rotor blades 16. However, in an alternative embodiment, the rotor hub 18 may include more or less than three rotor blades 16. The rotor blades 16 rotate the rotor hub 18 to enable kinetic energy to be transferred from the wind into usable mechanical energy, and subsequently, electrical energy. Specifically, the hub 18 may be rotatably coupled to an electric generator (not illustrated) positioned within the nacelle 14 for production of electrical energy.

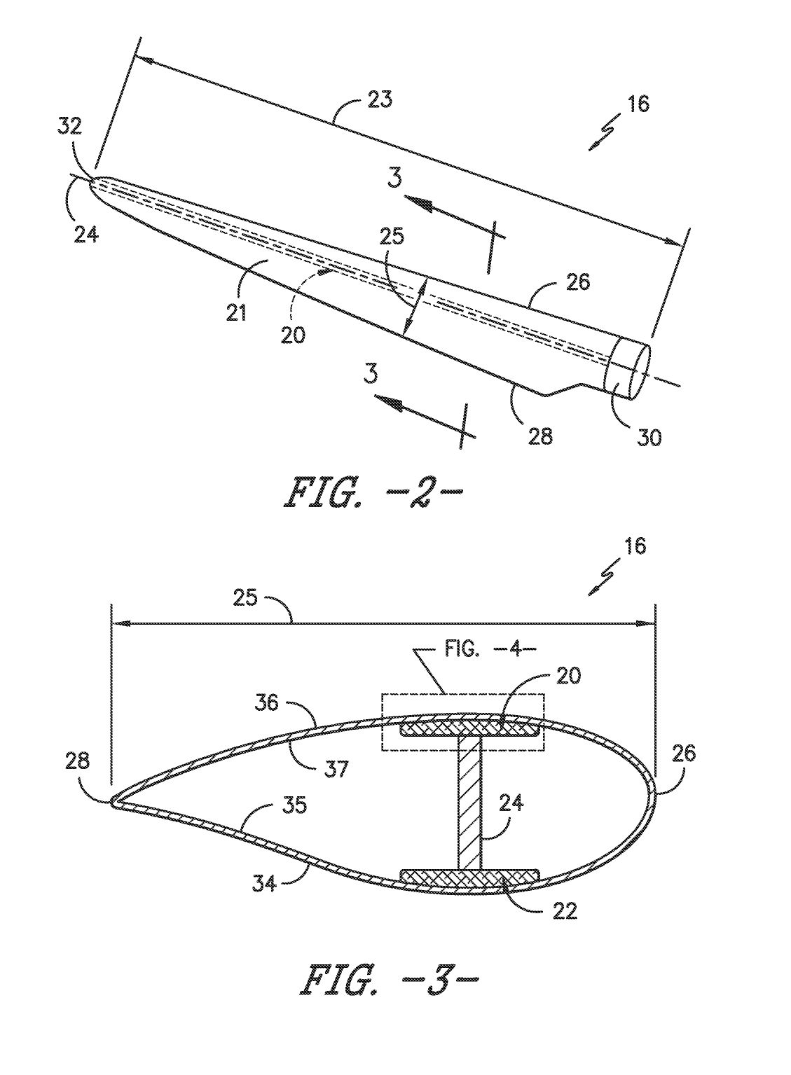

Referring to FIGS. 2 and 3, one of the rotor blades 16 of FIG. 1 is illustrated in accordance with aspects of the present subject matter. In particular, FIG. 2 illustrates a perspective view of the rotor blade 16, whereas FIG. 3 illustrates a cross-sectional view of the rotor blade 16 along the sectional line 3-3 shown in FIG. 2. As shown, the rotor blade 16 generally includes a blade root 30 configured to be mounted or otherwise secured to the hub 18 (FIG. 1) of the wind turbine 10 and a blade tip 32 disposed opposite the blade root 30. A body shell 21 of the rotor blade generally extends between the blade root 30 and the blade tip 32 along a longitudinal axis 27. The body shell 21 may generally serve as the outer casing/covering of the rotor blade 16 and may define a substantially aerodynamic profile, such as by defining a symmetrical or cambered airfoil-shaped cross-section. The body shell 21 may also define a pressure side 34 and a suction side 36 extending between leading and trailing ends 26, 28 of the rotor blade 16. Further, the rotor blade 16 may also have a span 23 defining the total length between the blade root 30 and the blade tip 32 and a chord 25 defining the total length between the leading edge 26 and the trialing edge 28. As is generally understood, the chord 25 may generally vary in length with respect to the span 23 as the rotor blade 16 extends from the blade root 30 to the blade tip 32.

In several embodiments, the body shell 21 of the rotor blade 16 may be formed as a single, unitary component. Alternatively, the body shell 21 may be formed from a plurality of shell components. For example, the body shell 21 may be manufactured from a first shell half generally defining the pressure side 34 of the rotor blade 16 and a second shell half generally defining the suction side 36 of the rotor blade 16, with such shell halves being secured to one another at the leading and trailing ends 26, 28 of the blade 16. Additionally, the body shell 21 may generally be formed from any suitable material. For instance, in one embodiment, the body shell 21 may be formed entirely from a laminate composite material, such as a carbon fiber reinforced laminate composite or a glass fiber reinforced laminate composite. Alternatively, one or more portions of the body shell 21 may be configured as a layered construction and may include a core material, formed from a lightweight material such as wood (e.g., balsa), foam (e.g., extruded polystyrene foam) or a combination of such materials, disposed between layers of laminate composite material.

Referring particularly to FIG. 3, the rotor blade 16 may also include one or more longitudinally extending structural components configured to provide increased stiffness, buckling resistance and/or strength to the rotor blade 16. For example, the rotor blade 16 may include a pair of longitudinally extending spar caps 20, 22 configured to be engaged against the opposing inner surfaces 35, 37 of the pressure and suction sides 34, 36 of the rotor blade 16, respectively. Additionally, one or more shear webs 24 may be disposed between the spar caps 20, 22 so as to form a beam-like configuration. The spar caps 20, 22 may generally be designed to control the bending stresses and/or other loads acting on the rotor blade 16 in a generally spanwise direction (a direction parallel to the span 23 of the rotor blade 16) during operation of a wind turbine 10. Similarly, the spar caps 20, 22 may also be designed to withstand the spanwise compression occurring during operation of the wind turbine 10.

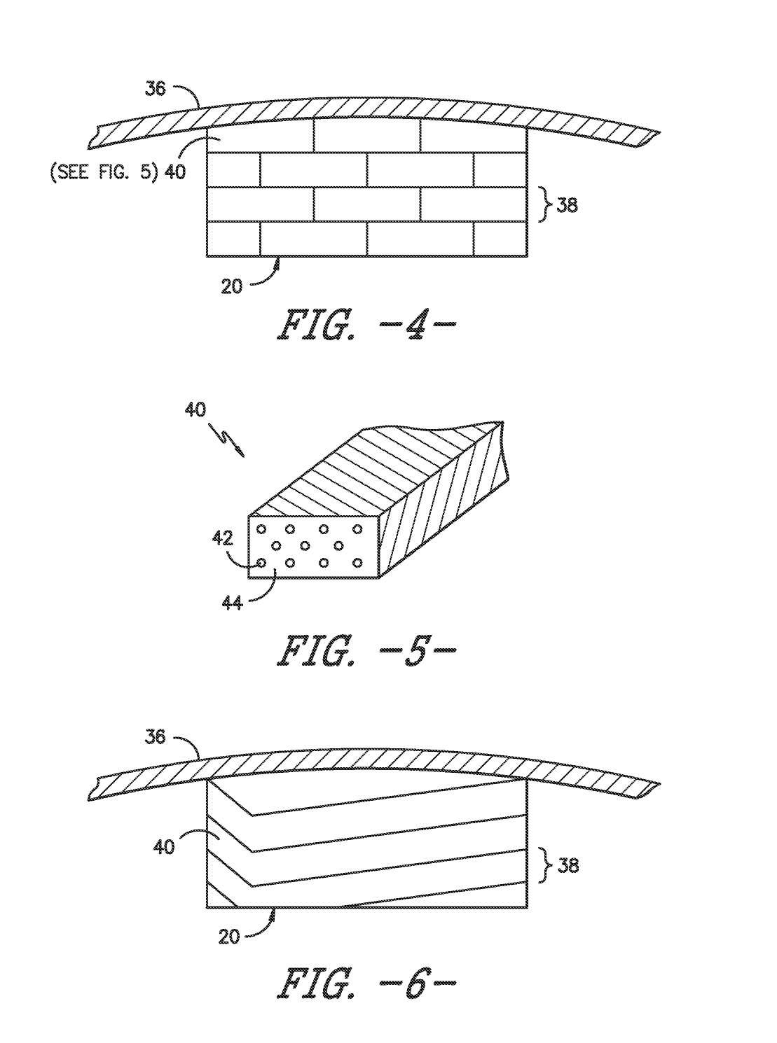

Referring now to FIG. 4, a cross-sectional view of a spar cap 20 constructed of a plurality of pultruded members 40 arranged in layers 38 according to the present disclosure. In addition, FIG. 5 illustrates a detailed, cross-sectional view of one of the pultruded members 40 of FIG. 4. As shown in FIG. 4, the pultruded members 40 are aligned side-by-side to form a single layer 38. The layers 38 are then stacked atop one another and joined together, for example, by vacuum infusion or any other suitable method. As shown in the illustrated embodiment of FIG. 5, each of the pultruded members 40 are constructed of a plurality of fibers 42 (e.g. fibers, fiber bundles, and/or woven, braided, or veil fabrics) joined together with a cured resin material 44. More specifically, in various embodiments, the fibers 42 may include glass fibers, carbon fibers, or any other suitable fiber materials. Further, in certain embodiments, the resin material 44 may include any suitable resin, including but not limited to polyester, polyurethane, polybutylene terephthalate (PBT), polyethylene terephthalate (PET), vinylester, epoxy, or similar. It should be understood that the pultruded members 40 of the present disclosure are pre-cured, pre-fabricated components manufactured using any suitable methods known in the art. Thus, in accordance with certain aspects of the present disclosure, a plurality of pultruded members 40 can be then joined together to form the spar cap 20. More specifically, the pultruded members may be joined and/or secured together via vacuum infusion, adhesive, semi-preg material, pre-preg material, or any other suitable joining method.

Referring now to FIGS. 6-9, further embodiments of pultruded members 40 for use in constructing rotor blade components (e.g., spar caps) according to the present disclosure are illustrated. More specifically, the pultruded members 40 include one or more interlocking edges 50 having a predetermined geometry. Thus, adjacent pultruded members 40 may be connected or self-aligned via corresponding interlocking edges 50. For example, as shown in FIG. 6, one embodiment of a spar cap 20 having interlocking pultruded members 40 according to the present disclosure is illustrated. More specifically, in the illustrated embodiment, the spar cap 20 includes single-component layers 38, i.e. the pultruded members 40 make up the entire thickness of each layer 38. Further, each of the interlocking pultruded members 40 may include a substantially chevron or V-shape cross-section that self-aligns with an adjacent component 40 and/or layer 38. Once the pultruded members 40 and/or layers 38 are arranged, the components 40 can be joined together, for example, by vacuum infusion or by applying adhesive between the components 40 and/or layers 38.

The pultruded members 40 may be manufactured using any suitable method for manufacturing pre-cured, pre-fabricated parts known in the art. For example, in a particular embodiment, as mentioned multiple fibers may be impregnated with a resin material. The impregnated fibers may then be cured so as to form the pultruded members 40. More specifically, the impregnated fibers may be cured and formed by heating the fibers in a heated die. For example, in certain embodiments, the heated die may include a mold cavity corresponding to the shape of the interlocking edges 50 such that the mold cavity forms the desired shape in the completed part. The pultruded members 40 are then arranged such that adjacent members 40 interconnect or self-align with each other. In addition, after connecting or self-aligning the pultruded members 40, the connected layers 38 may be secured together to form the rotor blade component, e.g. via vacuum infusing or bonding the components and/layers together via an adhesive, a semi-preg material, and/or a pre-preg material.

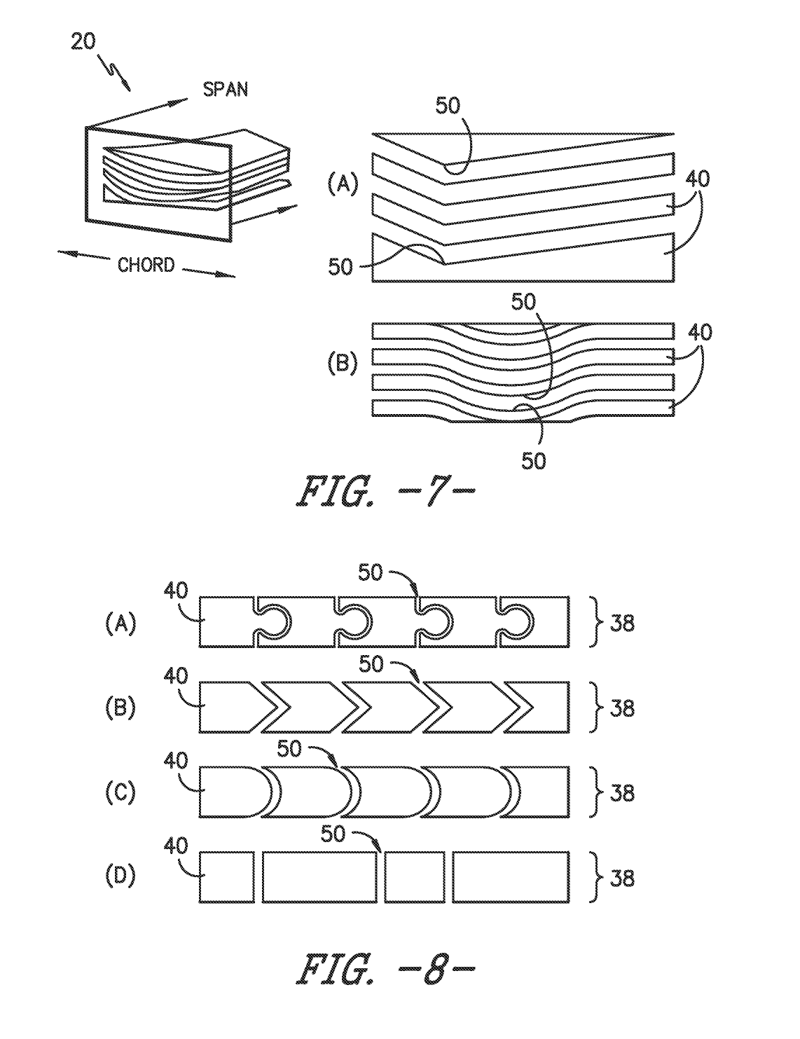

Referring particularly to FIG. 7, a more detailed view of various spar caps 20 according to the present disclosure is illustrated. More specifically, a perspective view of a spar cap 20 is shown illustrating the span and chord directions, as well as multiple cross-sectional views of the spar cap 20 illustrating different embodiments of the arranged pultruded members 40 having interlocking edges 50. For example, FIG. 7(A) illustrates the embodiment of FIG. 6 with space between each of the pultruded members 40 to further depict the interlocking edges 50, whereas FIG. 7(B) illustrates another embodiment of the pultruded members 40 having arcuate or rounded interlocking edges 50. It should be understood that the interlocking edges 50 may have any suitable cross-sectional shape that allows the pultruded members 40 and/or layers 38 to self-align and/or interconnect with each other. For example, as generally shown in the figures, the interlocking edges 50 of the pultruded members 40 may have any of the following cross-sectional shapes: dovetail, arcuate, rectangular, square, V-shaped, U-shaped, ball joint, or similar. Further, the rotor blade components according to the present disclosure may include any number of components 40 and/or layers 38 interlocked in any suitable configuration. Therefore, it should be understood that the embodiments illustrated in the figures are illustrated for example purposes only and are not meant to be limiting.

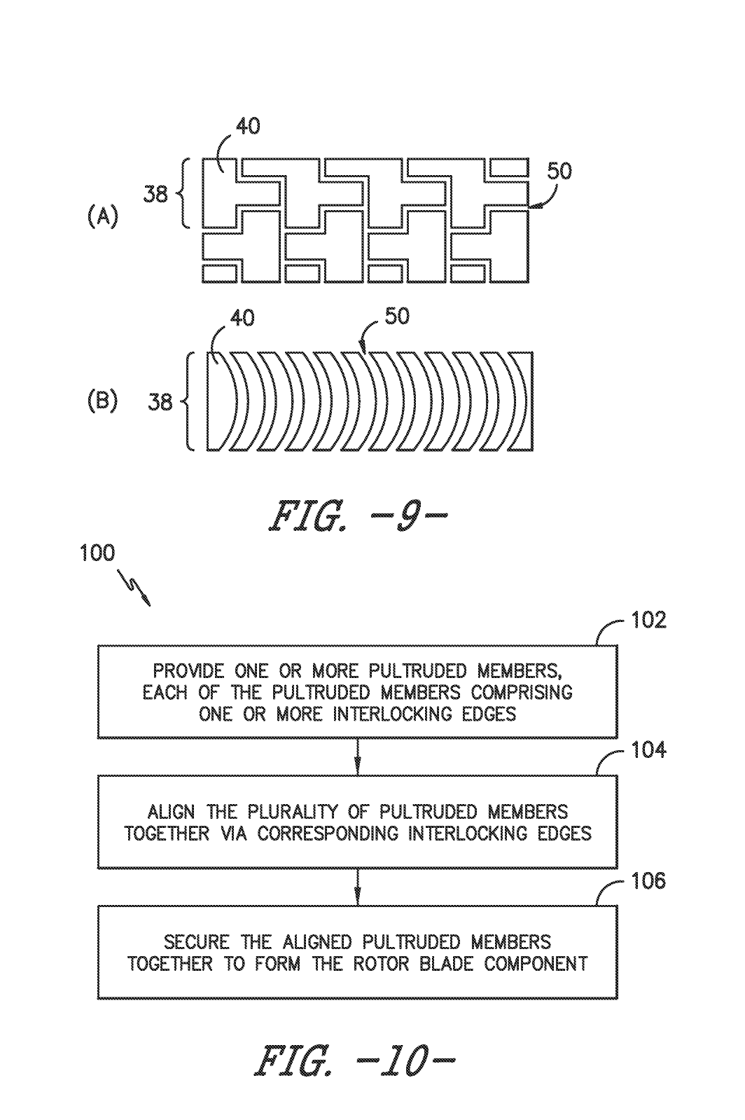

In addition, as shown in FIGS. 8 and 9, the interlocking edges 50 of the pultruded members 40 may correspond to interlocking side edges (FIGS. 8(A), 8(B), 8(C), 8(D), 9(A), and 9(B) of the pultruded members 40, interlocking top and bottom edges (FIGS. 7(A), 7(B), 9(A) of the pultruded members 40, or both. Thus, in certain embodiments, the pultruded members 40 may be connected or interlocked via corresponding interlocking side edges and/or interlocking top and bottom edges of adjacent pultrusions 40. More specifically, as shown in FIG. 8, a plurality of pultruded members 40 are interlocked via interlocking side edges 50 to form each layer 38. Further, as shown in FIG. 9(A), the rotor blade component may have both interlocking pultruded members 40 and interlocking layers 38 (e.g. the components 40 may have interlocking side edges and interlocking top and bottom edges). In still further embodiments, as shown in FIG. 9(B), the rotor blade component may include a plurality of interlocking pultruded members 40 that form a single, full thickness layer 38.

It should also be understood that the pultruded members 40 as described herein may be used to construct various other rotor blade components, in addition to the spar cap 20. For example, in certain embodiments, the pultruded members 40 may be used to construct the shear web 24, a root ring, or any other rotor blade component that can benefit from being constructed of a pultruded parts as described herein.

The present disclosure is also directed to methods for manufacturing rotor blade components as described herein. For example, as shown in FIG. 10, a flow diagram of a method 100 of manufacturing a rotor blade component of a wind turbine is disclosed. At 102, the method 100 includes providing one or more pultruded members, each of the pultruded members having one or more interlocking edges. Another step 104 includes connecting or aligning the plurality of pultruded members together via corresponding interlocking edges. The method 100 also includes securing the connected pultruded members together to form the rotor blade component (step 106).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade component for a wind turbine, the rotor blade component comprising:
a plurality of pultruded members arranged in one or more layers, each of the pultruded members constructed of a plurality of fibers joined together via a cured resin material,
wherein each of the plurality of pultruded members comprises one or more interlocking edges, and wherein adjacent pultruded members are aligned together via corresponding interlocking edges.

2. The rotor blade component of claim 1, wherein the rotor blade component comprises at least one of a spar cap, a shear web, or a root ring.

3. The rotor blade component of claim 1, wherein the one or more interlocking edges correspond to at least one of interlocking side edges, interlocking top edges or interlocking bottom edges.

4. The rotor blade component of claim 3, wherein adjacent pultruded members of one layer are aligned together via corresponding interlocking side edges.

5. The rotor blade component of claim 3, wherein adjacent pultruded members of different layers are aligned together via corresponding interlocking top and bottom edges.

6. The rotor blade component of claim 1, wherein the interlocking edges comprise at least one of the following cross-sectional shapes: dovetail, arcuate, rectangular, square, V-shaped, U-shaped, or ball joint.

7. The rotor blade component of claim 1, wherein the aligned pultruded members are further joined together via at least one of vacuum infusion, an adhesive, a pre-preg material, or a semi-preg material.

8. The rotor blade component of claim 1, wherein the one or more fibers comprises at least one of glass fibers or carbon fibers.

9. The rotor blade component of claim 1, wherein the at least one resin material further comprises at least one of polyester, polyurethane, polybutylene terephthalate (PBT), polyethylene terephthalate (PET), vinylester, or epoxy.

10. A rotor blade of a wind turbine, the rotor blade comprising:
a blade root and a blade tip;
a leading edge and a trailing edge;
a suction side and a pressure side; and,
at least one spar cap configured on an internal surface of either or both of the pressure or suction sides, the spar cap comprising a plurality of pultruded members arranged in one or more layers, each of the pultruded members constructed of a plurality of fibers joined together via a cured resin material, each of the plurality of pultruded members comprising one or more interlocking edges, wherein adjacent pultruded members are aligned together via corresponding interlocking edges.

11. The rotor blade of claim 10, wherein the rotor blade component comprises at least one of a spar cap, a shear web, or a root ring.

12. The rotor blade of claim 10, wherein the one or more interlocking edges correspond to at least one of interlocking side edges, interlocking top edges or interlocking bottom edges.

13. The rotor blade of claim 12, wherein adjacent pultruded members of one layer are aligned together via corresponding interlocking side edges.

14. The rotor blade of claim 12, wherein adjacent pultruded members of different layers are aligned together via corresponding interlocking top and bottom edges.

15. The rotor blade of claim 10, wherein the interlocking edges comprise at least one of the following cross-sectional shapes: dovetail, arcuate, rectangular, square, V-shaped, U-shaped, or ball joint.

16. The rotor blade of claim 10, wherein the aligned pultruded members are further joined together via at least one of vacuum infusion, an adhesive, a pre-preg material, or a semi-preg material.

17. A method of manufacturing a rotor blade component of a wind turbine, the method comprising:
providing one or more pultruded members, each of the pultruded members comprising one or more interlocking edges;
aligning the plurality of pultruded members together via corresponding interlocking edges; and,
securing the aligning pultruded members together to form the rotor blade component.

18. The method of claim 17, wherein the rotor blade component comprises at least one of a spar cap, a shear web, or a root ring.

19. The method of claim 17, wherein aligning the pultruded members together via the interlocking edges further comprises aligning at least one of corresponding interlocking side edges or interlocking top and bottom edges of adjacent pultruded members.

20. The method of claim 17, wherein securing the aligned pultruded members together to form the rotor blade component further comprises joining the pultruded members together via at least one of vacuum infusion, an adhesive, a pre-preg material, or a semi-preg material.
